(19) United States
(12) Patent Application Publication
(10) Pub. No.: US 2017/0219290 A1
(43) Pub. Date: Aug. 3, 2017

(54) Microwave Composite Heating Furnace

(71) Applicants: Chubu University Educational Foundation, Kasugai-shi, Aichi (JP); PRADEEP METALS LIMITED, Navi Mumbai (IN)

(72) Inventors: Motoyasu Sato, Kasugai-shi, Aichi (JP); Hibiki Ito, Kasugai-shi, Aichi (JP); Keiichiro Kashimura, Kasugai-shi, Aichi (JP); Kazuhiro Nagata, Kasugai-shi, Aichi (JP)

(73) Assignees: Chubu University Educational Foundation, Kasugai-shi, Aichi (JP); PRADEEP METALS LIMITED, Navi Mumbai (IN)

(21) Appl. No.: 15/501,144

(22) PCT Filed: Jul. 31, 2015
(86) PCT No.: PCT/JP2015/003889

§ 371 Date: Feb. 1, 2017

(30) Foreign Application Priority Data
Aug. 3, 2014 (JP) 2014-158278

(51) Int. Cl. F27D 11/12; H05B 6/80; F27B 14/14; F27B 14/04; F27B 14/10

(52) U.S. Cl. CPC F27D 11/12; F27B 14/04; F27B 14/10; F27B 14/14; H05B 6/80

(57) ABSTRACT

The present invention addresses the problem of providing a heating furnace that sufficiently exhibits the microwave effect produced by microwave heating and allows economical heating taking advantage of the characteristics of each heating method. The provided microwave composite heating furnace (1) is equipped with: a housing (10); a heating container (11) for accommodating and heating an object to be heated; a heating means (12) for heating the heating container (11) from the outside; a microwave irradiation device (13); a to-be-heated object supplying device (14) that supplies the object to be heated to the inside of the heating container (11); a gas introducing means (15) for introducing gas into the heating container (11); and a gas recovery means (16) for recovering the gas generated when heating the object to be heated. The heating container (11) comprises a material that has high electrical conductivity so as to reflect microwaves and confine the microwaves inside and that has high heat resistance so as not to react with the heated object, thereby confining microwaves irradiated into the heating container (11) not through the outer wall of the heating container, and allowing an improvement in electromagnetic field density.

### CROSS REFERENCE TO RELATED APPLICATIONS

This application claims benefit of priority from International Patent Application No. PCT/JP2015/003889 filed on Jul. 31, 2015, which claims benefit of priority from Japanese Patent Application No. 2014-158278 filed on Aug. 3, 2014, both of which are fully incorporated herein by reference in their entirety.

### BACKGROUND OF THE INVENTION

Field of the Invention

The present invention relates to a microwave composite heating furnace to heat a heating object using the combination of microwave and external heating such as a burner.

Description of the Background Art

Since the late 1980s, it has been known that high power microwave is emitted to a heating object to provide, for example:

(1) a lower reaction temperature;
(2) a shorter reaction time; and
(3) the generation of highly-pure material (reaction selectivity).

These behaviors are chemical and physical behaviors different from those obtained by the conventional heating by flame or high-temperature gas. These behaviors are called a “microwave effect” caused because microwave electromagnetic energy directly acts on the molecular structure of the substance before the electromagnetic energy relaxes into heat. Many attempts have been made to apply this effect to many fields.

In the case of a heating furnace providing a heating operation only by microwave as schematically shown in (A) of FIG. 4, equipment (microwave source) for supplying microwave energy requires a cost higher by about one digit than that of external heat-type equipment such as a gas burner for supplying the same amount of thermal energy, thus requiring a much higher cost. In the case of the technique as disclosed in Patent Document 1 for example, such a configuration is used that allows microwave to pass through heat insulating material and heat resistance material to thereby enter the interior of a furnace body. Thus, a method as shown in (B) of FIG. 4 has been suggested to use a combination of microwave and the conventional external heating using a heat source such as a burner having low apparatus and operation costs (e.g., Patent Document 2).

### PRIOR ART DOCUMENTS

### Patent Documents

Patent Document 1: Japanese Unexamined Patent Application Publication No. 2002-130960

Patent Document 2: Japanese Unexamined Patent Application Publication No. 2013-216943

### Non-Patent Documents

Non-Patent Document 1: Roy, R., Peelamedu, P. D., Hurtt, L., Cheng, J. P. and Agrawal, D., “Definitive experimental evidence for Microwave Effects: Radically new effects of separated E and H fields, such as decrystallization of oxides in seconds,” Mat. Res. Innovat., 6, (2002) pp. 128-140

Non-Patent Document 2: B.C. Towe, “Induced Ultra-High Frequency Ultrasonic Vibration as the Driving Force for Reported Sub-Thermal Microwave Effects on Materials” Materials Science and Technology (MS & T) 2009, Oct. 25-29, Pittsburgh, Pa. Copy Right MS & T09 New Roles for Electric and Magnetic Fields.

Non-Patent Document 3: M. C. Steele and B. Vural, “Wave Interactions in Solid State Plasmas” McGrow Hill (1968) Chap. 8-9

Non-Patent Document 4: Landau Lifshitz (translated by Satou Tsunezo), “Dansei Riron” Tokyo Tosho pp. 192-193

### Problems to be Solved

The inventor has performed the following study regarding the microwave effect.

The application of the transition state theory discussing the reaction speed has been expanded to a solid phase, a liquid phase, and a surface as well as photochemical, catalyst, and isotope. Since 1980s, in the sintering using microwave or various chemical reactions, phenomena called the microwave effect or the non-thermal effect such as reduced activation energy or a rapid and selective chemical reaction that cannot occur in a general heating operation have been found. In 2002, R. Roy et al. showed an experiment result that the mystery of the microwave effect exists in a relaxation process in which the electromagnetic wave energy in substance relaxes into heat that is kinetic energy having a high disorder (Non-Patent Document 1). In 2009, B. C. Towe pointed out “the similarity between microwave in a high-temperature range and ultrasonic products” (Non-Patent Document 2). This research has an objective of explaining the experiment result by applying the transition state theory to a nonequilibrium system called a microwave disturbance.

Substance is substantially spatially non-uniform such as the grain boundary due to the polycrystallity, powders, or clusters. Microwave has an electromagnetical field acting on the electric charge of such a surface. When this action is combined with a mechanical property of the distortion and an electrical property owned by the substance such as piezoelectricity or molecular magnetism, then waves called Electro-kinetic waves (EKW) are driven (Non-Patent Document 3). It has been theoretically demonstrated that such elastic waves have an attenuation rate that is proportional to the square root of the frequency number when the substance has a polycrystalline structure, powders or the like defined by a particle diameter a and the condition “frequency ω>>temperature conductivity χ/a²” is satisfied (Non-Patent Document 4). For example, when the constant of alumina material having a particle diameter of a few microns is applied, then ultrasound waves of the microwave waveband are driven and can be expressed by the dispersion formula in the solid state plasma. The next disadvantage is that microwave has the photon energy on the order of 10⁻⁵ eV that is excessively low compared with the energy 1 eV of the chemical bonding. Thus, there may be a case where the chemical reaction cannot be driven even when electrons in the molecules in the microwave electromagnetical field are oscillated. Since this EKW has a phase velocity on the order of that of a sound wave, the inventor has reached a working hypothesis according to which the thermal vibration of ions in the crystal lattice causes a Landau damping causing a collisionless damping in a speed space, which consequently causes the wave energy to be accumulated in the lattice vibration in the collisionless process.

Next, the inventor added the first order fluctuation “f₀(v)·(v−vₚₕ)·g(v−vₚₕ)” to the speed distribution function “f₀(v)” of the heat equilibrium system to derive, based on the absolute reaction speed theory of Eyring, the reaction speed constant K* to the microwave nonequilibrium system. It was assumed that “ξ²<<RT/m*” was established for the sound wave amplitude “ξ.”

$${K}^{*} = \frac{{Q}^{†}}{{Q}_{a} {Q}_{b}} [ \frac{RT}{h} + \frac{{m}^{*} {ξ}^{2}}{h} ] exp ( \frac{- {E}^{*}}{RT} ) \qquad ( Equation 1 )$$

where “Qa” and “Qb” represent partition functions of the reactants A and B; “Q†” represents one-dimensional translational partition function; “T” represents a thermodynamical temperature, “h” represents the Planck's constant; and “E*” represents activation energy.

The first term in [ ] of the right side of the above formula shows the chemical reaction speed due to general heat based on the well-known transition state theory. The second term represents the effect to promote the chemical reaction by the perturbation by microwave. This shows that the microwave effect is more remarkable with the increase of the fluctuation due to microwave, i.e., the increase of the energy “ξ²” of the ultrasound waves of the amplitude “ξ.”

The derived reaction constant shows that the microwave energy causes the fluctuation of the charged particles in the substance to drive small sound wave vibration and the fluctuation is accumulated to thereby cause the growth of the sound wave vibration having aligned phases, thereby acquiring the energy equal to that of thermal vibration. In order to realize the industrial application of the theory, it is required to derive the relation between the specific numerical value of the amplitude of this grown sound wave and the microwave power. The calculated growth time of the sound wave amplitude cannot be longer than the time required for the sound wave energy to relax into heat. Thus, the calculated growth time of the sound wave amplitude is equivalent to the time required for the sound wave energy to relax into heat.

Based on the description of Non-Patent Document 4, the attenuation distance and the time of the sound waves were calculated. The result showed that the time required for the sound wave energy to relax into heat increased with the decrease of the microwave entropy was, i.e., the decrease of the frequency dispersion. Specifically, the reaction constant “k*” can be represented, as shown in the following formula, by parameters that can be measured such as the temperature “T,” the microwave power “p_{μ},” the frequency “ω,” and the microwave “Q value” (“Q=ω/Δω,” where “Δω” represents the frequency dispersive width). The reference numeral “vₚₕ” shows the sound velocity and the reference numeral “vₜₕ” shows the heat speed and the ratio therebetween is on the order of 1.

$${k}^{*} = \frac{{q}^{†}}{{q}_{a} {q}_{b}} [ \frac{RT}{h} + 2 \sqrt{π} \frac{{v}_{th}}{{v}_{ph}} Q \frac{{P}_{μ} / ω}{h} ] exp ( \frac{- {E}^{*}}{RT} ) \qquad ( Equation 2 )$$

Microwave having a smaller frequency dispersion are desired in order to supply the simple harmonic motion energy (5) shown in FIG. 5 within a time shorter than the time required for the ultrasound wave vibrations by microwave to relax into heat.

As described above, through the keen research, the inventors have found that the microwave effect is remarkable in proportional with the microwave energy (the square of the electromagnetical field density). In the case of the above conventional technique, the microwave dissipation in the heating space, the loss due to the furnace wall during the microwave irradiation or the like prevents the microwave from having a higher electromagnetical field density, thus failing to provide a sufficient microwave effect. In the case of the conventional microwave heating, no attention was paid on Q showing the quality of microwave. Thus, the time required for the relaxation to heat was frequently short, thus requiring a further larger microwave source.

Thus, in order to provide a sufficient microwave effect, a disadvantage must be solved that means for merely increasing the output is used, causing the increase of the apparatus cost and the operation cost.

In view of the above, it is an objective of the present invention to provide a microwave composite heating furnace that can sufficiently provide the microwave composite heating furnace by the heating using microwave and that can provide the economical heating utilizing the characteristics of the respective heating methods.

### SUMMARY OF THE INVENTION

### Means For Solving Problems

In order to achieve the above objective, there is provided, as first technical means to be applied to the invention, a microwave composite heating furnace including: a housing made of heat insulating material; a heating container arranged inside the housing, the heating container configured to accommodate a heating object so as to heat the heating object; a microwave irradiation apparatus configured to cause a microwave generation apparatus to generate microwave, and cause a microwave transmission unit to transmit the microwave, so that the heating object stored in the heating container is irradiated with the microwave without bypassing an outer wall of the heating container; and a heating unit configured to heat the heating container from outside the heating container, wherein the heating container is formed mainly of electrically conductive carbon material, and is formed to allow microwave to be reflected inside the heating container, so that the heating object can be heated by microwave and the heating unit.

Further, there is provided, as second technical means to be applied to the invention, the microwave composite heating furnace as the first technical means to be applied to the invention described above, wherein the heating container is made of composite material formed by binding silicon carbide particles with carbon.

Further, there is provided, as third technical means to be applied to the invention, the microwave composite heating furnace as the first or second technical means to be applied to the invention described above further including: a gas introduction unit configured to introduce gas for adjusting atmosphere into the heating container; and a gas collection unit configured to collect gas generated upon heat-processing of a heating object so as to process the gas.

Further, there is provided, as fourth technical means to be applied to the invention, the microwave composite heating furnace as the third technical means to be applied to the invention described above, wherein the microwave transmission unit includes a waveguide, and the wave guide is connected with the gas introduction unit and the gas collection unit, and gas introduced through the gas introduction unit or mixed gas obtained by mixing gas introduced through the gas introduction unit and gas processed in the gas collection unit is introduced through a tip end of the waveguide into an interior of the heating container.

Further, there is provided, as fifth technical means to be applied to the invention, the microwave composite heating furnace as the first, second, or third technical means to be applied to the invention described above, wherein the microwave transmission unit is configured such that microwave is guided into an interior of the heating container, through the use of a microwave reflection unit configured such that microwave generated by the microwave generation apparatus is allowed to be reflected.

Further, there is provided, as sixth technical means to be applied to the invention, the microwave composite heating furnace as the fifth technical means to be applied to the invention described above, wherein the microwave transmission unit includes an infrared reflection unit configured to allow infrared rays emitted from a heated heating object to be reflected so as to guide the infrared rays into the heating container.

Further, there is provided, as seventh technical means to be applied to the invention, the microwave composite heating furnace as the sixth technical means to be applied to the invention described above, wherein the infrared reflection unit is configured as a reflecting surface formed in a microwave reflecting surface of the microwave reflection unit in a stepwise manner.

Further, there is provided, as eighth technical means to be applied to the invention, the microwave composite heating furnace as the fifth, sixth, or seventh technical means to be applied to the invention described above, wherein the microwave irradiation apparatus is configured such that a plurality of the microwave generation apparatuses are arranged at a housing-side wall so as to surround a heating container, and a wavefront of microwave generated by the plurality of the microwave generation apparatuses is controlled, thereby capable of forming any irradiation face.

Further, there is provided, as ninth technical means to be applied to the invention, the microwave composite heating furnace as the first, second, third, fourth, fifth, sixth, seventh, or eighth technical means to be applied to the invention described above, further comprising: a heating object supply unit configured to supply a heating object into the heating container; and a collection unit configured to collect heat-processed heating objects.

### Advantageous Effects of the Invention

According to the invention described in the first aspect, the heat supply to a heating object is mainly carried out by the thermal flow given by heating unit to a heating container. Microwave is allowed to be selectively absorbed by the heating object having a high temperature. By sealing microwave in the interior of the heating container to improve the electromagnetical field, the microwave effect can be sufficiently provided prior to the relaxation of microwave to thermal energy. The heating unit can be used to provide a uniform temperature distribution and can provide improved reaction efficiency and energy efficiency, thus providing the heating realizing low apparatus and operation costs.

As described in the invention in the second aspect, the composite material formed by binding silicon carbide particles with carbon favorably reflects microwave and has high heat resistance and can be preferably used as material of the heating container.

According to the invention described in the third aspect, the gas introduction unit is used to introduce gas for adjusting atmosphere into the heating container. The gas collection unit can be used to collect and process gas generated when a heating object is heat-processed.

According to the invention described in the fourth aspect, the gas introduced through the gas introduction unit or mixed gas of gas introduced through the gas introduction unit and gas processed in the gas collection unit is introduced from the tip end of the waveguide to the interior of the heating container. Thus, reaction gas generated from the heating object can be discharged from the interior of the heating container. Furthermore, gas blown from the tip end of the waveguide can prevent the interior of the waveguide from being contaminated by dust, reaction gas and the like or being subjected to plasma generation.

According to the invention described in the fifth aspect, the microwave reflection unit can reflect microwave generated by the microwave generation apparatus to guide the microwave into the interior of the heating container. This can provide an increased freedom degree to the arrangement of the microwave generation apparatus. This can also electrically change the frequencies, phases, and oscillation outputs of a plurality of pieces of microwave to control the energy distribution and propagation direction of an emitted microwave beam, thus eliminating the need to provide a mechanical rotation mechanism such as a stirrer in a high temperature.

According to the invention described in the sixth aspect, infrared rays emitted from a heated heating object can be returned to the interior of the heating container and can be used for a heating operation, thus realizing a more efficient heating operation.

According to the invention described in the seventh aspect, the microwave reflection unit and the infrared reflection unit can be formed in a simple configuration in an integrated manner.

According to the invention described in the eighth aspect, the wavefront of microwave can be controlled to electrically change the microwave directionality, thus forming any irradiation face. This can consequently eliminate the need of a stirring mechanism or the like for the heating container, thus providing the uniform heating of a heating object.

According to the invention described in the ninth aspect, the heating object supply unit is used to supply a heating object into the heating container and the collection unit can be used to collect heat-processed heating objects. The supply and collection operations can be both carried out with any of continuous or batch-type methods.

### BRIEF DESCRIPTION OF THE DRAWINGS

For more thorough understanding of the present invention and advantages thereof, the following descriptions should be read in conjunction with the accompanying drawings in which:

FIG. 1 is a schematic view illustrating the configuration and the internal structure of the microwave composite heating furnace of the first embodiment.

FIG. 2 is a schematic view illustrating the configuration and the internal structure of the microwave composite heating furnace of the second embodiment.

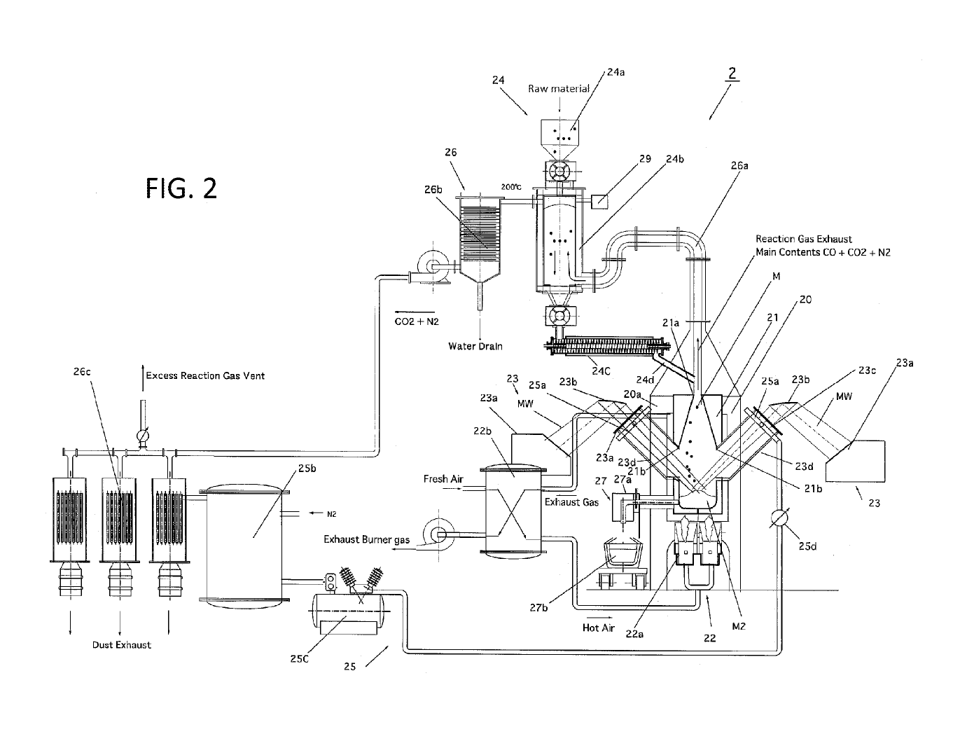

FIG. 3 is a schematic view illustrating the configuration and the principle of an infrared reflection unit.

FIG. 4 is a schematic view illustrating the configuration of a conventional microwave heating furnace.

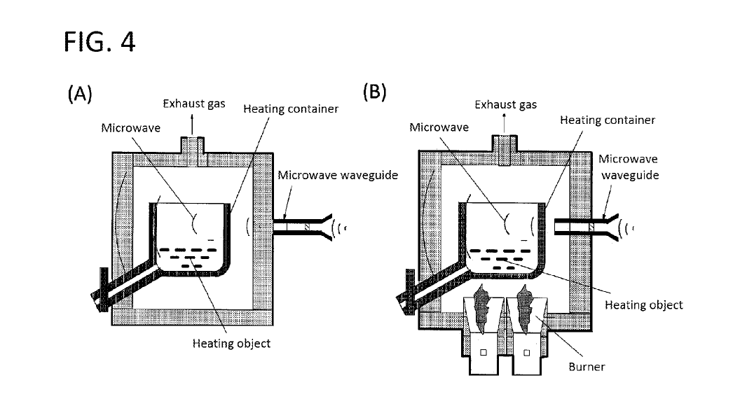

FIG. 5 is a schematic view illustrating the flow of the energy supply by the microwave heating and the conventional heating.

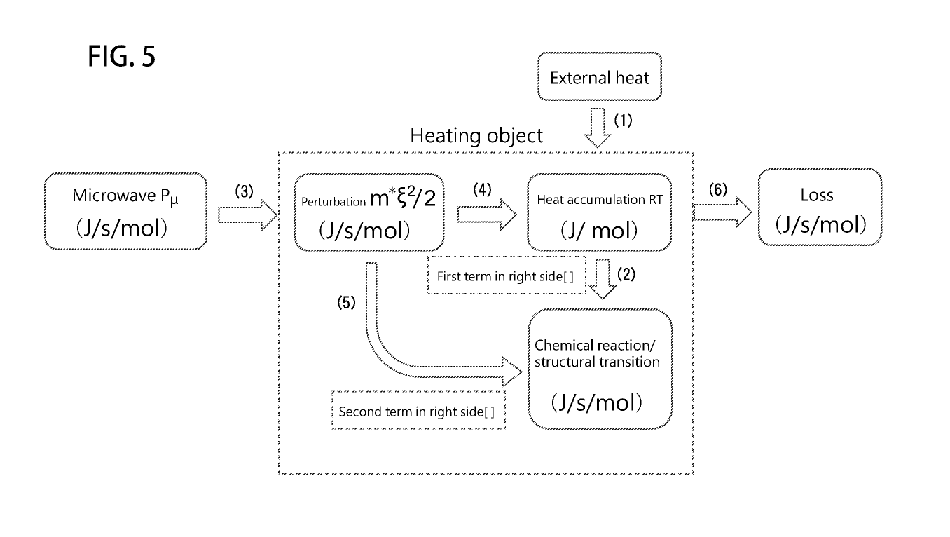

### DESCRIPTION OF EMBODIMENTS OF THE INVENTION

### First Embodiment

The following section will describe the first embodiment of a microwave composite heating furnace of the present invention with reference to the drawings.

(Configuration Of Microwave Composite Heating Furnace)

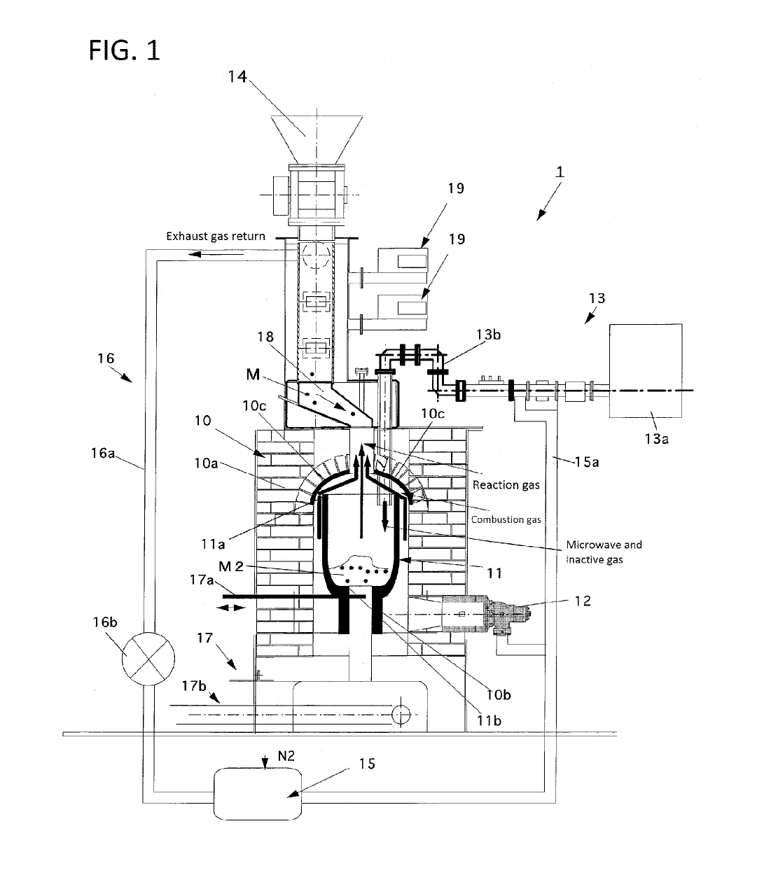

As shown in FIG. 1, a microwave composite heating furnace 1 includes: a housing 10, a heating container 11 that is provided in the interior of the housing 10 and that stores therein a heating object and that heats the heating object, a heating unit 12 for externally heating the heating container 11, a microwave irradiation apparatus 13, a heating object supply apparatus 14 for supplying a heating object into the heating container 11, a gas introduction unit 15 for introducing gas for adjusting atmosphere into the heating container 11, a gas collection unit 16 for collecting and processing gas caused when a heating object is heat-processed, and a not-shown control apparatus.

The housing 10 consists of a refractory wall 10a formed by heat insulating material such as refractory brick and stores therein the heating container 11 via a seat 10b. In this embodiment, the heating container 11 is provided at a position at which the heating container 11 can be heated from the lower side by the heating unit 12. The upper part of the heating container 11 has a heating object supply path 18 communicating with a heating object supply path 18 (which will be described later) and has a shield wall 10c formed so as to cover a part of an opening 11a of the heating container 11. The shield wall 10c is provided with an inside panel to reflect microwave and infrared rays to return the microwave and infrared rays to the interior of the heating container 11. In this embodiment, this inside panel is formed by the same material as that of the heating container 11.

The heating container 11 is made of such material that is highly-conductive to reflect microwave to seal the microwave in the interior and that is highly-resistant and that does not react with a heating object. Metal material such as stainless cannot be used because of the decrease of the electrical microwave and infrared rays and strength in a high-temperature range, the melting or the like. Heat-resistant alloy also has a high price and is inappropriate because of the increase of the chemical activity and the like. According to the present invention, through the keen investigation of various materials, such material was used that included electrically conductive carbon material as a main component. Specifically, such material is preferred that is a sintered body obtained by binding silicon carbide powders by carbon and that includes silicon carbide at a content rate of 20 to 70% and that has a 1/10 or more higher electrical conductivity to high-frequency waves than that of copper. In this embodiment, composite sintering material was used that made of 35 weight % of silicon carbide particles and carbon. The heating container 11 used in this embodiment is coated with an oxide such as silicon oxide in order to prevent the reaction with a heating object. Material including carbon material as a main component can be, for example, the one obtained by binding aggregate such as aluminum nitride or aluminum oxide by carbon, graphite, or carbide-base conductive ceramics.

The heating container 11 is formed to have a crucible-like shape in which the upper part has the opening 11a and the neighborhood of the bottom part has a slot 11b through which a heat-processed heating object is taken out. The slot 11b has a gate valve 17a of a collection unit 17 to open or close the slot 11b. The gate valve 17a can be used to open or close the slot 11b to provide the switching between the storage of a heating object and the removal of a heat-processed heating object. When the slot 11b is opened by the gate valve 17a, the heat-processed heating object is sent from the slot 11b to a carrier apparatus 17b. The carrier apparatus 17b carries the heat-processed heating object to the next step. The collection unit 17 includes the gate valve 17a and the carrier apparatus 17b and acts as means to take out a heat-processed heating object. The collection unit 17 can use any of continuous or batch-type methods.

The heating unit 12 consists of a gas burner, a liquid incineration burner, an electrical heater or the like that is configured in the interior of the housing 10 so as to be able to externally heat the heating container 11.

The microwave irradiation apparatus 13 includes a microwave generation apparatus 13a and a waveguide 13b that functions as microwave transmission unit to allow microwave generated by the microwave generation apparatus 13a to be directly emitted through the opening 11a of the heating container 11 to the interior. The waveguide 13b is provided at such a position that allows microwave to be emitted to a heating object stored in the heating container 11 without bypassing the outer wall of the heating container 11. Microwave generated by the microwave generation apparatus 13a is preferably 0.9 to 100 GHz in order to improve the rate at which the heating object absorbs microwave. In this embodiment, microwave has 2.45 GHz.

The heating object supply apparatus 14, which supplies a heating object to the heating container 11, is provided in the upper part of the heating container 11 via the heating object supply path 18 including a scraper. The heating object supply apparatus 14 can be a known quantitative supply apparatus such as a hopper.

The gas introduction unit 15 is connected to the waveguide 13b by a piping 15a. The gas introduction unit 15 is configured to be able to introduce, into the heating container 11, gas for adjusting atmosphere in the heating container 11 (e.g., inactive gas such as CO₂ or nitrogen to prevent the oxidation of a heating object during a heating operation and to discharge reaction gas to the exterior of the system) from the tip end of the waveguide 13b.

The gas collection unit 16 includes a piping 16a communicating with the upper part of the heating object supply path 18 and a compressor 16b provided in the piping 16a. The piping 16a is connected to the gas introduction unit 15. The heating object supply path 18 acts as a path to supply a heating object to the heating container 11 and also acts as a gas distribution path to collect combustion gas generated from the heating unit 12 or gas generated from a heating object.

A side wall section of the heating object supply path 18 has two preheating microwave irradiation apparatuses 19 to pre-heat a heating object when the heating object is supplied from the heating object supply apparatus 14 to the heating container 11. This allows the heating object to be heated prior to the input to the heating container 11, thus improving the heating processing efficiency.

Although not shown, the microwave composite heating furnace 1 also includes a temperature measurement unit to measure the temperature of the heating container 11 and the like. Conventionally, an optical pyrometer or the like has been used as a temperature measurement unit in order to prevent the influence by microwave. However, since there is no leakage of microwave at the exterior of the heating container 11, the side wall of the heating container 11 can have a thermocouple to function as a temperature measurement unit.

(Heating Method)

Next, the following section will describe a method of using the heating furnace 1 to heat a heating object by explaining the manufacture of sponge iron or pig iron as an example.

First, the gas introduction unit 15 introduces inactive gas such as CO₂ or nitrogen (nitrogen in this embodiment) from the tip end of the waveguide 13b to the interior of the heating container 11 to fill the interior with the inactive gas. Then, the heating unit 12 heats the heating container 11 and the interior of the housing 10 to 1050 to 1250° C. when sponge iron is manufactured and heats the heating container 11 and the interior of the housing 10 to 1370 to 1400° C. when pig iron is manufactured.

Next, the heating object supply apparatus 14 inputs a predetermined amount of heating objects M (raw material) to the interior of the heating container 11 via the heating object supply path 18.

Raw material is powders obtained by mixing ironstone with a carbon source such as coke or carbon at a predetermined ratio that can cause a sufficient reduction reaction. The raw material is not limited to powders and also can take various forms such as the one having a pellet-like shape.

The preheating microwave irradiation apparatus 19 can be used to preheat the raw material passing through the heating object supply path 18. This can consequently reduce the heat input at the heating container 11. When ironstone includes hematite, then ironstone can be preheated at 500 to 800° C. to reduce the ironstone to magnetite having a high microwave absorption rate so that microwave can be more absorbed easily.

Next, the microwave generation apparatus 13a of the microwave irradiation apparatus 13 is used to generate microwave. The microwave is introduced via the waveguide 13b into the heating container 11 and is emitted to the heating object M2. The microwave is reflected at the inner surface of the heating container 11 and the shield wall 10c and thus can be sealed within the heating container 11. This can consequently reduce the microwave loss and can improve the electromagnetical field density. The heating object is heated by the heating unit 12. Thus, the microwave can have an improved electromagnetical field density, thereby sufficiently establishing the microwave effect prior to the relaxation of the microwave to thermal energy.

The raw material irradiated with microwave is rapidly heated because of the heat generated by ironstone and a carbon source constituting the material, respectively. When the ironstone contacts with the carbon source, a ferric oxide is reduced in a prioritized manner, thus generating highly-pure melting pig iron or sponge iron. A shaft furnace is operated at a temperature of 1550° C. However, in the present invention, the raw material heated at a temperature of 1200° C. can have a reduction reaction and the raw material heated at a temperature of 1400° C. or less can have a melting state.

The heating by microwave can increase the speed at which the raw material is heated and can provide the microwave effect to reduce the concentration of impurities such as silicon, magnesium, phosphoric acid, titanium, sulfur, or manganese. Furthermore, the heating speed can be controlled to thereby adjust the amount of carbon carburized in iron.

The heating of the raw material causes the generation of volatile gas such as hydrogen gas, methane gas, nitrogen gas, carbon monoxide gas, or carbon dioxide gas and reaction gas such as CO, CO₂ and the like. These gases are pushed out by gas blown by the gas introduction unit 15 from the tip end of the waveguide 13b into the heating container 11 and is discharged from within the heating container 11. The gas blown from the tip end of the waveguide 13b can prevent the interior of the waveguide 13b from being contaminated by the intrusion of dust, reaction gas or the like or being subjected to plasma generation.

Since the gas collection unit 16 generates upward air current within the housing 10, reaction gas and the like is discharged from within the housing 10 together with combustion gas generated by the heating unit 12. This prevents the combustion gas from intruding into the heating container 11.

The gas discharged from within the housing 10 flows from the lower side to the upper side in the heating object supply path 18. During this, the heating object passing through the heating object supply path 18 is heated and CO included in the gas reduces a part of the heating object.

The gas collected by the gas collection unit 16 is pressurized by the compressor 16b. Then, the resultant gas is mixed with nitrogen by the gas introduction unit 15 and is blown from the tip end of the waveguide 13b into the heating container 11. This can provide a heating operation without discharging a large amount of reaction gas and the like to the exterior. Furthermore, the reaction gas and the like having a high temperature can be used to heat the gas blown through the waveguide 13b. This can consequently provide an efficient heating operation without causing the raw material from having a decreased temperature.

The atmosphere in the heating container 11 such as an oxygen partial pressure also can be changed by changing the mixing ratio of the inactive gas introduced from the gas introduction unit 15 and the gas collected by the gas collection unit 16. This can consequently control carbon and the impurity concentration in iron.

The sponge iron or pig iron generated by heating the raw material can be taken out to the exterior by opening the gate valve 17a provided at the slot 11b of the heating container 11.

The impurities in the ironstone are not reduced and are in a solid state. Thus, the impurities are not included in the melting reduced iron. Thus, even when low-quality ironstone including a large amount of impurities is used, highly-pure pig iron can be obtained and can be preferably used for the refining of iron and steel.

The above-described heating processing can be carried out as a batch processing to input raw material in an intermittent manner or as a continuous processing to continuously input the raw material to perform the heating processing to continuously take out sponge iron or pig iron.

The above-described heating method can lower the temperature at which ironstone is reduced (i.e., reaction temperature). The reaction time also can be shortened by the combination of the rapid heating by microwave and the external heating by the heating unit 12. Furthermore, ironstone contacting with a carbon source can provide the prioritized reduction of ferric oxide, thus generating highly-pure melting pig iron or sponge iron. By sufficiently providing the microwave effect as described above combined with the external heating by the heating unit 12, the temperature of the heating container 11 can be maintained and a low-cost heating method can be realized.

### Modified Example

The gas collection unit 16 also can be configured to include a heat exchanger. This can allow the heat exhaust such as reaction gas to be used for the preheating of a heating object, a cogeneration burner or the like.

The heating container 11 can be formed to have a bottle-like shape by reducing the diameter of the opening 11a. This can reduce the opening 11a and thus can seal microwave into the internal in a more effective manner, thus improving the electromagnetical field density.

According to a method to supply a heating object, a heating object that is connected to a rotary kiln and that is preheated can be also supplied. This allows an existing rotary kiln to be used as preliminary heating preliminary reduction equipment. The sufficient outlet temperature of the rotary kiln is about 800° C. Thus, the existing equipment can have about two-times-higher processing speed, thus significantly contributing to the resource saving and energy waving.

In the above-described embodiment, a heating object (raw material) was heated that was obtained by mixing the ironstone for manufacturing sponge iron or pig iron with a carbon source. However, the invention is not limited to this. The heating furnace 1 of the present invention can be used to heat nonconductive material such as various oxides. For example, the heating furnace 1 of the present invention also can be used to melt or solidify radioactive waste, for example, to collect precious metal in an urban mine, or to manufacture semiconductor silicon raw material. The frequency, output or the like of microwave can be appropriately set depending on a heating object.

### Effect Of The First Embodiment

According to the heating furnace 1 of this embodiment, heat supply to a heating object is mainly carried out by the thermal flow given from the heating unit 12 to the heating container 11. Microwave is selectively absorbed by the heating object having a high temperature. Microwave sealed in the heating container 11 can improve the electromagnetical field density, thereby sufficiently providing the microwave effect prior to the relaxation of the microwave to thermal energy. The heating unit 12 can provide a uniform temperature distribution and can improve the reaction efficiency and the energy efficiency, thus providing a heating operation with low apparatus and operation costs.

### Second Embodiment

### Second Embodiment

The following section will describe a microwave composite heating furnace according to the second embodiment with reference to the drawings.

A microwave composite heating furnace 2 includes a housing 20, a heating container 21 that is provided in the housing 20 and that stores and heats a heating object, a heating unit 22 to externally heat the heating container 21, a microwave irradiation apparatus 23, a heating object supply apparatus 24 to supply a heating object into the heating container 21, a gas introduction unit 25 to introduce gas for adjusting atmosphere into the heating container 21, a gas collection unit 26 for collecting and processing gas that is caused when a heating object is heat-processed, and a not-shown control apparatus.

The housing 20 made of of a refractory wall 20a formed by heat insulating material such as a refractory brick and stores therein the heating container 21.

The heating container 21 is made of material similar to that of the heating container 11 of the first embodiment and is formed to have a crucible-like shape having a diameter reduced toward the opening 21a. This can consequently allow the neighborhood of the opening 21a to reflect microwave and infrared rays, thus more efficiently sealing the microwave and infrared rays within the heating container 21. The bottom part communicates with a slot 27a of a collection unit 27 formed to be able to open or close in order to take out a heat-processed heating object. The heat-processed heating object is sent from the slot 27a to a receiving container 27b.

As in the heating unit 12 of the first embodiment, the heating unit 22 consists of a gas burner, a liquid incineration burner, an electrical heater or the like configured in the housing 20 so as to be able to externally heat the heating container 21. A gas burner 22a was used in this case.

The combustion gas generated by the gas burner 22a is allowed to flow from the upper part of the housing 20 to the heat exchanger 22b and is heat-exchanged with external air and is subsequently discharged to the exterior. The heat-exchanged external air is supplied to the gas burner 22a as combustion air.

The microwave irradiation apparatus 23 includes a microwave generation apparatus 23a, a reflection mirror 23b that reflects microwave generated by the microwave generation apparatus 23a to guide the microwave to the heating container 11, a microwave window 23c through which microwave passes and is emitted to the interior of the heating container 21, and a microwave irradiation path 23d through which microwave having passed the microwave window 23c is emitted from the side wall of the heating container 21 to the interior. The microwave irradiation path 23d communicates with the interior of the heating container 21 via a microwave emission opening 21b provided in the side wall of the heating container 21 and the other end is blocked from the exterior by the microwave window 23c.

The microwave irradiation apparatuses 23 are provided at a plurality of positions so as to surround the heating container 21.

The microwave MW generated in the microwave generation apparatus 23a is guided by the reflection mirror 23b to the microwave window 23c and passes the microwave window 23c and the microwave irradiation path 23d and is emitted through the microwave emission opening 21b to a heating object M2 provided in the heating container 21.

The respective plurality of microwave irradiation apparatuses 23 perform a microwave phase control and can control the wavefront of microwave so that the microwave directionality can be electrically changed, thus forming any irradiation face. This can provide the uniform heating of a heating object without requiring a stirring mechanism for the heating container 21 or the like. When the microwave generation apparatus 23a is configured to include a plurality of microwave generation elements (e.g., semiconductor elements), a phased array method can be used to control the wavefront of microwave so that a single microwave irradiation apparatus 23 can be used to change the microwave direction. The microwave generation apparatus 23a can use a frequency phase lock method to perform a microwave frequency control.

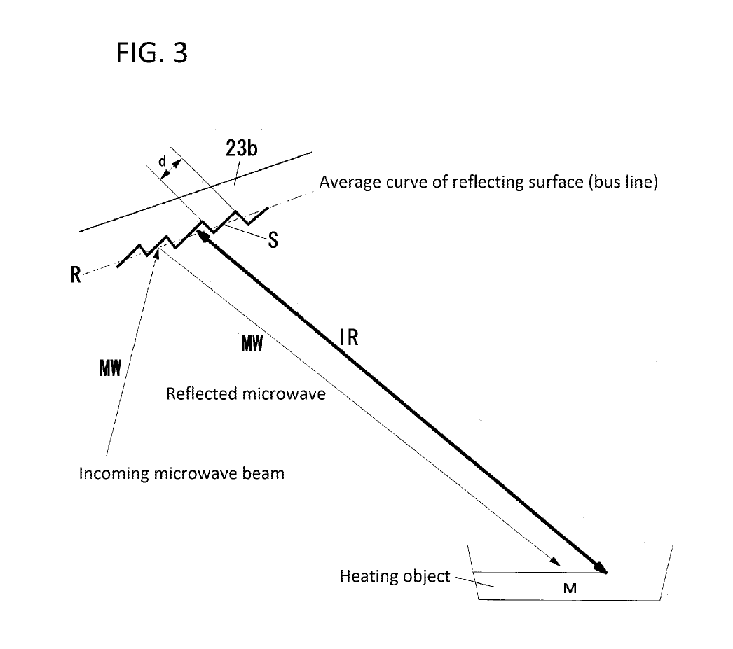

The reflecting surface reflecting the microwave MW of the reflection mirror 23b is formed by material reflecting microwave (e.g., copper material, stainless steel). The reflecting surface is also preferably configured to be able to reflect infrared rays. For example, the reflecting surface can be formed by material such as carbon that reflects microwave and that absorbs infrared rays to reemit the infrared rays. The microwave can be separated from the infrared rays by using the difference in the wavelength therebetween. This provides, as shown in FIG. 3, a groove-like infrared reflecting surface S formed in a stepwise manner to reflect the infrared rays IR to the reflecting surface (average reflecting surface R) in the original direction. The infrared reflecting surface S is formed on the reflecting surface so that the width d of 30 to 300 μm is formed in a step-wise manner. The infrared reflecting surface S has a width of about 1/100 of the microwave wavelength or about tens of times of the infrared ray wavelength. Since the microwave has a long wavelength, the microwave reflection direction is determined by the reflection direction by the average reflecting surface R. However, the infrared rays IR are reflected by the infrared reflecting surface S. Thus, the infrared reflecting surface S acts as an infrared reflection unit. The shape of the infrared reflecting surface S such as the inclination is set so that the infrared rays IR return to a heating object. This allows the infrared rays to return to the interior of the heating container 21, thus providing a more efficient heating operation. Furthermore, the microwave reflection unit and the infrared reflection unit can be formed in a simple configuration in an integrated manner.

The heating object supply apparatus 24 includes a hopper 24a, a preheating apparatus 24b connected to the hopper 24a, and a rotary feeder 24c continuing to the preheating apparatus 24b. The heating object supply apparatus 24 drops and supplies an accurately-controlled amount of heating objects via a drift tube 23d into the heating container 21.

The preheating apparatus 24b is connected to an exhaust pipe 26a provided at the upper part of the heating container 21. The preheating apparatus 24b also has a preheating microwave irradiation apparatus 29 as in the preheating microwave irradiation apparatus 19 of the first embodiment.

The gas introduction unit 25 includes a gas introduction member 25a to introduce gas through the microwave irradiation path 23d into the heating container 21, a buffer 25b, a compressor 25c, and a flow meter 25d.

The gas collection unit 26 includes a duct 26a to guide discharge gas such as reaction gas or atmosphere gas (e.g., nitrogen) generated from the heating container 21 to the preheating apparatus 24b, a capacitor 26b to concentrate water in gas discharged after being pre-heated by the preheating apparatus 24b to remove water, and a filter 26c to remove dust and the like.

The gas discharged from the heating container 21 is CO, CO₂, N₂, and the like having a high temperature (500 to 1000° C.) in the case of the manufacture of sponge iron or pig iron. This discharge gas is introduced via the duct 26a from the lower part of the preheating apparatus 24b to the interior and heats a heating object while flowing in the upward direction. During this, CO included in discharge gas reduces a part of the heating object. The exhaust gas from a preliminary reduction apparatus preferably has a temperature of 60 to 200° C.

The gas discharged after the pre-heated from the preheating apparatus 24b is allowed to pass the capacitor 26b and the filter 26c to remove unnecessary matters and is subsequently sent to the buffer 25b. Then, the resultant gas is mixed with nitrogen introduced from a not-shown nitrogen source and the resultant gas is pressurized by the compressor 25c. Then, the resultant gas is sent through the flow meter 25d and a predetermined amount of the gas is introduced by the gas introduction member 25a via the microwave irradiation path 23d into the heating container 21. As a result, the gas in the heating container 21 is discharged from the heating container 21. The gas introduction member 25a is blown from the neighborhood of the microwave window 23c to the interior of the heating container 21. This can prevent the interior of the microwave irradiation path 23d from being contaminated by the intrusion of dust, reaction gas and the like or being subjected to plasma generation.

As described above, the microwave composite heating furnace 2 can provide an efficient heating while achieving the efficient use of heat and gas.

### Effect of the Second Embodiment

The microwave composite heating furnace 2 can provide the following effect in addition to the effect that can be provided by the microwave composite heating furnace 1 of the first embodiment.

By controlling the wavefront of microwave, the microwave directionality can be electrically changed, thus forming any irradiation face. This can provide the uniform heating of a heating object without requiring a stirring mechanism or the like for the heating container 21.

More efficient heating can be achieved because infrared rays emitted from a heated heating object can be returned into the heating container 21 and can be used for a heating operation.

### Other Embodiments

As a microwave irradiation apparatus, a microwave heating furnace heating method disclosed in (Japanese Unexamined Patent Application Document No. 2013-11384) developed by the inventors also can be used. A microwave source is modularized and is configured as a wave source unit having the directionality by a phase control. Microwave antennas obtained by synthesizing this wave source unit are provided to surround a heating container. Directional microwave beams are emitted by a reflection mirror to the center of the heating container and are focused so as to be maximum at the heating object surface, thereby heating the heating object.

### REFERENCE NUMERALS

| | |
|---|---|
| 1, 2 Microwave composite heating furnace | 10 Housing |
| 11 Heating container | 12 Heating unit |
| 13 Microwave irradiation apparatus | 13a Microwave |
| apparatus | generation |
| 13b Waveguide | 14 Heating object supply |
| apparatus | |
| 15 Gas introduction unit | 16 Gas collection unit |
| 18 Heating object supply path | |
| 19 Preheating microwave irradiation apparatus | 20 Housing |
| 21 Heating container | 22 Heating unit |
| 23 Microwave irradiation apparatus | 23a Microwave |
| apparatus | generation |
| 23b Reflection mirror | 23c Microwave window |
| 23d Microwave irradiation path | 24 Heating object supply |
| apparatus | |
| 25 Gas introduction unit | 26 Gas collection unit |
| 29 Preheating microwave generation apparatus | |

1. A microwave composite heating furnace comprising:
a housing made of heat insulating material;
a heating container arranged inside the housing, the heating container configured to accommodate a heating object so as to heat the heating object;
a microwave irradiation apparatus configured to cause a microwave generation apparatus to generate microwave, and cause a microwave transmission unit to transmit the microwave, so that the heating object stored in the heating container is irradiated with the microwave without bypassing an outer wall of the heating container; and
a heating unit configured to heat the heating container from outside the heating container,
wherein the heating container is formed mainly of electrically conductive carbon material, and is formed to allow microwave to be reflected inside the heating container, so that the heating object can be heated by microwave and the heating unit.

2. The microwave composite heating furnace according to claim 1 wherein the heating container is made of composite material formed by binding silicon carbide particles with carbon.

3. The microwave composite heating furnace according to claim 1 further comprising:
a gas introduction unit configured to introduce gas for adjusting atmosphere into the heating container; and
a gas collection unit configured to collect gas generated upon heat-processing of a heating object so as to process the gas.

4. The microwave composite heating furnace according to claim 2 further comprising:
a gas introduction unit configured to introduce gas for adjusting atmosphere into the heating container; and
a gas collection unit configured to collect gas generated upon heat-processing of a heating object so as to process the gas.

5. The microwave composite heating furnace according to claim 3 wherein
the microwave transmission unit includes a waveguide, the waveguide connected with the gas introduction unit and the gas collection unit, and
gas introduced through the gas introduction unit or mixed gas obtained by mixing gas introduced through the gas introduction unit and gas processed in the gas collection unit is introduced through a tip end of the waveguide into an interior of the heating container.

6. The microwave composite heating furnace according to claim 4 wherein
the microwave transmission unit includes a waveguide, the waveguide is connected with the gas introduction unit and the gas collection unit, and
gas introduced through the gas introduction unit or mixed gas obtained by mixing gas introduced through the gas introduction unit and gas processed in the gas collection unit is introduced through a tip end of the waveguide into an interior of the heating container.

7. The microwave composite heating furnace according to claim 1 microwave transmission unit is configured such that microwave is guided into an interior of the heating container, through the use of a microwave reflection unit configured such that microwave generated by the microwave generation apparatus is allowed to be reflected.

8. The microwave composite heating furnace according to claim 2 wherein the microwave transmission unit is configured such that microwave is guided into an interior of the heating container, through the use of a microwave reflection unit configured such that microwave generated by the microwave generation apparatus is allowed to be reflected.

9. The microwave composite heating furnace according to claim 3 wherein the microwave transmission unit is configured such that microwave is guided into an interior of the heating container, through the use of a microwave reflection unit configured such that microwave generated by the microwave generation apparatus is allowed to be reflected.

10. The microwave composite heating furnace according to claim 4 wherein the microwave transmission unit is configured such that microwave is guided into an interior of the heating container, through the use of a microwave reflection unit configured such that microwave generated by the microwave generation apparatus is allowed to be reflected.

11. The microwave composite heating furnace according to claim 7 wherein the microwave transmission unit includes an infrared reflection unit configured to allow infrared rays emitted from a heated heating object to be reflected so as to guide the infrared rays into the heating container.

12. The microwave composite heating furnace according to claim 8 wherein the microwave transmission unit includes an infrared reflection unit configured to allow infrared rays emitted from a heated heating object to be reflected so as to guide the infrared rays into the heating container.

13. The microwave composite heating furnace according to claim 9 wherein the microwave transmission unit includes an infrared reflection unit configured to allow infrared rays emitted from a heated heating object to be reflected so as to guide the infrared rays into the heating container.

14. The microwave composite heating furnace according to claim 10 wherein the microwave transmission unit includes an infrared reflection unit configured to allow infrared rays emitted from a heated heating object to be reflected so as to guide the infrared rays into the heating container.

15. The microwave composite heating furnace according to claim 11 wherein the infrared reflection unit is configured as a reflecting surface formed in a microwave reflecting surface of the microwave reflection unit in a stepwise manner.

16. The microwave composite heating furnace according to claim 12 wherein the infrared reflection unit is configured as a reflecting surface formed in a microwave reflecting surface of the microwave reflection unit in a stepwise manner.

17. The microwave composite heating furnace according to claim 13 wherein the infrared reflection unit is configured as a reflecting surface formed in a microwave reflecting surface of the microwave reflection unit in a stepwise manner.

18. The microwave composite heating furnace according to claim 14 wherein the infrared reflection unit is configured as a reflecting surface formed in a microwave reflecting surface of the microwave reflection unit in a stepwise manner.

19. The microwave composite heating furnace according to claim 11 wherein the microwave irradiation apparatus is configured such that a plurality of the microwave generation apparatuses are arranged at a housing-side wall so as to surround a heating container, and a wavefront of microwave generated by the plurality of the microwave generation apparatuses is controlled, thereby capable of forming any irradiation face.

20. The microwave composite heating furnace according to claim 1 further comprising:
a heating object supply unit configured to supply a heating object into the heating container; and
a collection unit configured to collect heat-processed heating objects.
